(19) United States
(12) Patent Application Publication
(10) Pub. No.: US 2008/0266071 A1
(43) Pub. Date: Oct. 30, 2008

(54) Passenger protection device for vehicle

(76) Inventor: Ryuichi Asada, Nakano-ku (JP)

Correspondence Address: WENDEROTH, LIND & PONACK, L.L.P., 2033 K STREET N. W., SUITE 800, WASHINGTON, DC, 20006-1021, US

(21) Appl. No.: 12/081,833

(22) Filed: Apr. 22, 2008

(30) Foreign Application Priority Data
Apr. 24, 2007 (JP) 2007-113817

(51) Int. Cl. B60Q 1/00

(52) U.S. Cl. 340/436

(57) ABSTRACT

A passenger protection device for a vehicle includes a satellite sensor which is disposed in a vehicle body, detects an impact applied to the vehicle body from an outside as a deceleration, and outputs data, and a control section which inflates an airbag arranged in a vehicle interior according to the data output from the satellite sensor. The control section and the satellite sensor are electrically connected by a connection line, the control section outputs an operation voltage of the satellite sensor via the connection line, the satellite sensor outputs the data to the control section via the connection line, and the control section includes a stabilization power source circuit which generates the operation voltage and a resistance provided between the stabilization power source circuit and a power source of the stabilization power source circuit.

### PRIORITY CLAIM

The present application is based on and claims priority from Japanese Patent Application No. 2007-113817, filed on Apr. 24, 2007, the disclosure of which is hereby incorporated by reference in its entirety.

### BACKGROUND OF THE INVENTION

1. Field of the Invention

The present invention relates to a passenger protection device for a vehicle.

2. Description of the Related Art

A passenger protection device for a vehicle, which protects a passenger in a vehicle interior when an impact is applied to a vehicle from the front and the side, is today in broad practical use. In such a passenger protection device for a vehicle, the impact applied from the outside is detected by a satellite sensor arranged in the vehicle body, and a control section inflates an airbag disposed in a central portion of a steering wheel, an instrument panel, a roof, or a door, for example, when the impact is a predetermined value or more, so as to protect a passenger from the impact.

The control section communicates with the satellite sensor by means of a signal line for loading the impact data detected by the satellite sensor. In addition to this signal line which conducts this communication, a power source line which supplies power to the satellite sensor from the control section is required between the control section and the satellite sensor. In order to reduce the costs, there is proposed a technique which shares the power source line and the signal line (refer to JP H09-226513A).

As described above, if the power source line and the signal line are shared between the control section and the satellite sensor, a circuit illustrated in FIG. 4 is generally considered. A control section body 110 and a satellite sensor 220 are connected by a connection line L1. As the power source of the satellite sensor 220, a stabilization power source circuit 112 is arranged in the control section body 110 on a downstream side of a battery, so as to stably operate the circuit if the voltage of the battery as a power source is decreased to some level. The control section body 110 supplies a voltage VREG (for example, 7V) to the satellite sensor 220 via the connection line L1. In addition, a resistance R1 is arranged between the stabilization power source circuit 112 and the satellite sensor 220, and the communication between the control section body 110 and the satellite sensor 220 is performed via the connection line L1 according to the change in an electric potential difference at both ends of the resistance R1. More particularly, the satellite sensor 220 changes the electric potential on the downstream side of the resistance R1 (satellite sensor 220 side) by the on/off operation of a switching element 224 provided in the satellite sensor 220, so as to change the electric potential difference between both ends of the resistance R1. According to the electric potential difference, a differential amplifier 113 of the control section body 110 outputs a signal synchronized with the on/off of the switching element 224. This signal is received by a CPU 111, and then the communication is conducted.

By the way, in general, the control section body 110 is substantially disposed in the central portion of the vehicle body in order not to become damaged by the impact from the outside, and the satellite sensor 220 is arranged near the outer circumference of the vehicle body so as to easily detect the impact from the outside. For this reason, the control section body 110 is significantly distanced from the satellite sensor 220, and thus, an external noise is easily mixed into the connection line (harness) which connects the control section body 110 and the satellite sensor 220, resulting in a communication error by the external noise.

An electric potential Vu on the upstream side of the resistance R1 is constant at the voltage VREG, whereas an electric potential Vd on the downstream side of the resistance R1 becomes an output voltage VH when the switching element 224 of the satellite sensor 220 is turned on or becomes an output voltage VL when the switching element 224 is turned off. For example, if VREG is 7V and VH is 5V, the electric potential difference between both ends of the resistance R1 is 2V at a maximum as illustrated in a timing chart in FIG. 5. Thereby, a communication error is easily caused even by the small output noise.

### SUMMARY OF THE INVENTION

The present invention has been made in view of the above problem, and an object of the present invention is to provide a passenger protection device for a vehicle which can conduct stable communication without being influenced by an external noise when sharing a power source line between a control section and a satellite sensor as a communication line.

In order to achieve the above object, the present invention relates to a passenger protection device for a vehicle, including a satellite sensor which is disposed in a vehicle body, detects an impact applied to the vehicle body from outside as a deceleration, and outputs data, and a control section which inflates an airbag arranged in a vehicle interior according to the data output from the satellite sensor, wherein the control section and the satellite sensor are electrically connected by a connection line, the control section outputs an operation voltage of the satellite sensor via the connection line, the satellite sensor outputs the data to the control section via the connection line, the control section includes a stabilization power source circuit which generates the operation voltage and a resistance provided between the stabilization power source circuit and a power source of the stabilization power source circuit, the satellite sensor changes an electric potential difference on both ends of the resistance according to an output of the data, and the control section loads the data of the satellite sensor according to the electric potential difference.

Preferably, the satellite sensor includes a switching element, and generates the data according to on/off of the switching element, so as to output the data.

Preferably, the control section includes a differential amplifier, and the differential amplifier outputs an output signal synchronized to the data according to the electric potential difference on the both ends of the resistance.

### BRIEF DESCRIPTION OF THE DRAWINGS

These and other features, aspects, and advantages of the present invention will become better understood with regard to the following description, appended claims, and accompanying drawings.

FIG. 1 is a block diagram illustrating a passenger protection device for a vehicle and peripheral devices according to an embodiment of the present invention.

FIG. 2 is a block diagram illustrating a control section body and a satellite sensor of the passenger protection device for a vehicle according to the embodiment of the present invention.

FIG. 3 is a timing chart in the communication between the control section body and the satellite sensor of the passenger protection device for a vehicle according to the embodiment of the present invention.

FIG. 4 is a block diagram illustrating a control section body and a satellite sensor of a passenger protection device for a vehicle according to a related art.

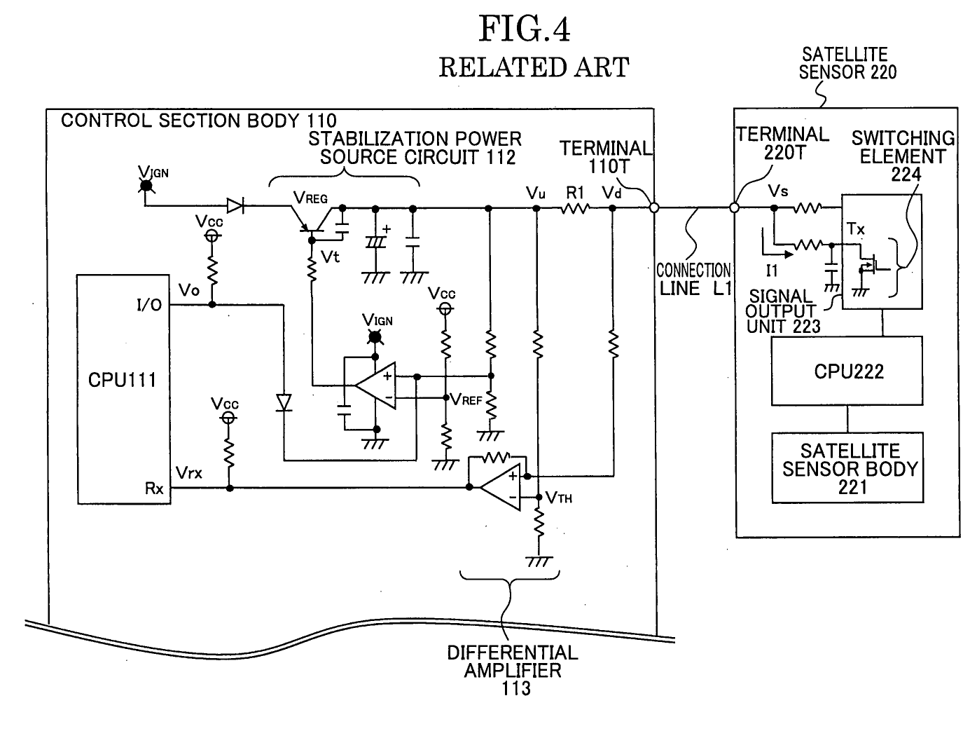

FIG. 5 is a timing chart in the communication between the control section body and the satellite sensor of the passenger protection device for a vehicle according to the related art.

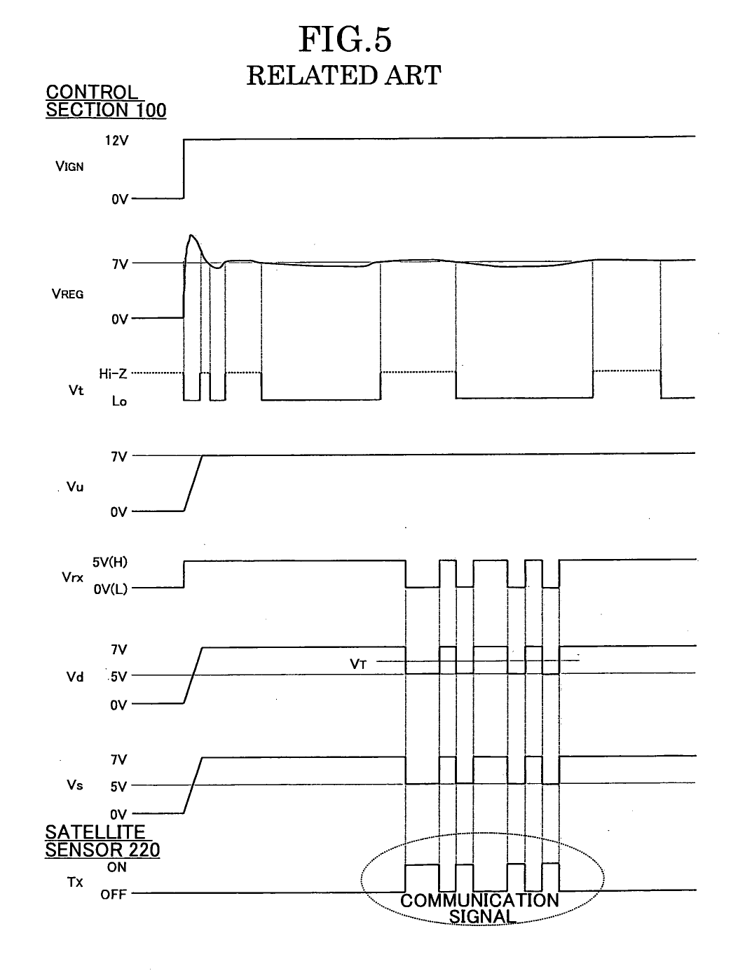

### DETAILED DESCRIPTION OF THE PREFERRED EMBODIMENTS

Hereinafter, an embodiment of the present invention will be described with reference to the accompanying drawings.

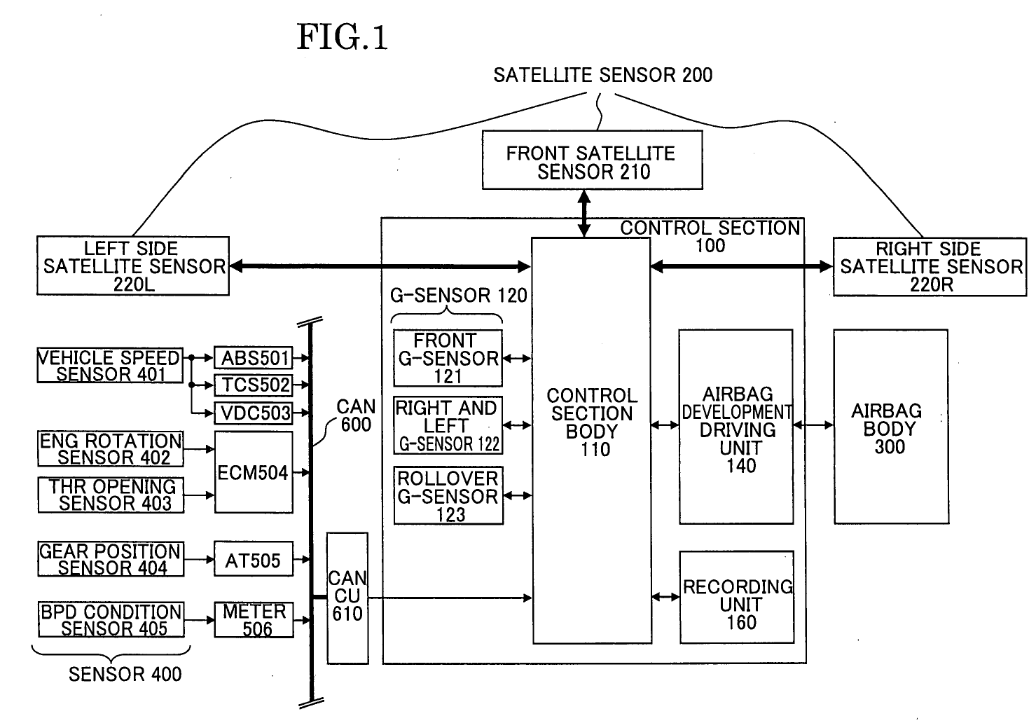

FIG. 1 is a block diagram illustrating a passenger protection device for a vehicle and peripheral devices according to the embodiment of the present invention.

The passenger protection device for a vehicle includes a control section 100 and a satellite sensor 200.

The control section 100 includes a control section body 110, a G-sensor 120 having a front G-sensor 121, a right and left G-sensor 122, and a rollover sensor 123, an airbag development driving unit 140, and a recording unit 160.

The control section body 110 loads the signals output from the satellite sensor 200 and the G-sensor 120, and outputs a signal for developing an airbag body 300 to the airbag development driving unit 140 according to the output signals and the detected time.

The control section body 110 records the signals output from the satellite sensor 200 and the G-sensor 120 in the recording unit 160 when outputting the signal for developing the airbag body 300.

The front G-sensor 121 detects a deceleration by the impact from the front, and outputs the detection signal to the control section body 110.

The right and left G-sensor 122 detects a deceleration by the impact from the right or left side, and outputs the detection signal to the control section body 110.

The rollover sensor 123 detects roll acceleration in the roll direction of the vehicle body, and outputs the detection signal to the control section body 110.

The airbag development driving unit 140 receives the inflating signal from the control section body 110, operates an inflator (not shown) of the airbag body 300, and inflates the airbag.

The output signals from the satellite sensor 200 and the G-sensor 120 are recorded in the recording unit 160 by the control section body 110.

A front satellite sensor 210 is disposed in a cross member (not shown) located inside a radiator grill, detects the impact applied to the front of the vehicle, and sends the detection signal to the control section body 110.

The right side satellite sensor 220R is disposed in a door frame (not shown) inside a right side door, detects the impact applied to the right side of the vehicle, and sends the detection signal to the control section body 110.

The left side satellite sensor 220L is disposed in a door frame (not shown) inside a left side door, detects the impact applied to the left side of the vehicle, and sends the detection signal to the control section body 110.

The airbag body 300 is disposed in a central portion of a steering wheel, an instrument panel, a roof, or a door, for example. The airbag is inflated by the activation of the inflator according to the signal from the airbag development driving unit 140.

The passenger protection device for a vehicle monitors the signals from various sensors 400 such as a vehicle speed sensor 401, an engine rotation sensor 402, a throttle opening sensor 403, a gear position sensor 404, and a brake pedal condition sensor 405 via a CAN (controller area network) 600 for interacting information in a vehicle interior and a CAN control unit 610 (CAN CU610 in FIG. 1), which is the control section of the CAN 600, and uses these signals for the inflating control of the airbag body 300 if required.

The vehicle speed sensor 401 controls the output of the development signal according to a vehicle speed. The output signal of the vehicle speed sensor is also used for an antilock brake system 501 (ABS 501 in FIG. 1), a traction control system 502 (TCS 502 in FIG. 1), and a vehicle dynamics control 503 (VDC 503 in FIG. 1), for example, via the CAN 600 and the CAN control unit 610.

The engine rotation sensor 402 (ENG rotation sensor 402 in FIG. 1) is connected to the CAN 600. The output signal of the engine rotation sensor 402 is used for the control system of an engine control unit 504 (ECM 504 in FIG. 1), for example.

The throttle opening sensor 403 (THR opening sensor 403 in FIG. 1) is also connected to the CAN 600. The output signal of the throttle opening sensor 403 is used for the control system of the engine control unit 504, for example.

The gear position sensor 404 is also connected to the CAN 600. The output signal of the gear position sensor 404 is used for the control system of an automatic transmission 505 (AT 505 in FIG. 1), for example.

The brake pedal condition sensor 405 (BPD condition sensor 405 in FIG. 1) is also connected to the CAN 600. The output signal of the brake pedal condition sensor 405 is used for the display system of a meter 506, for example.

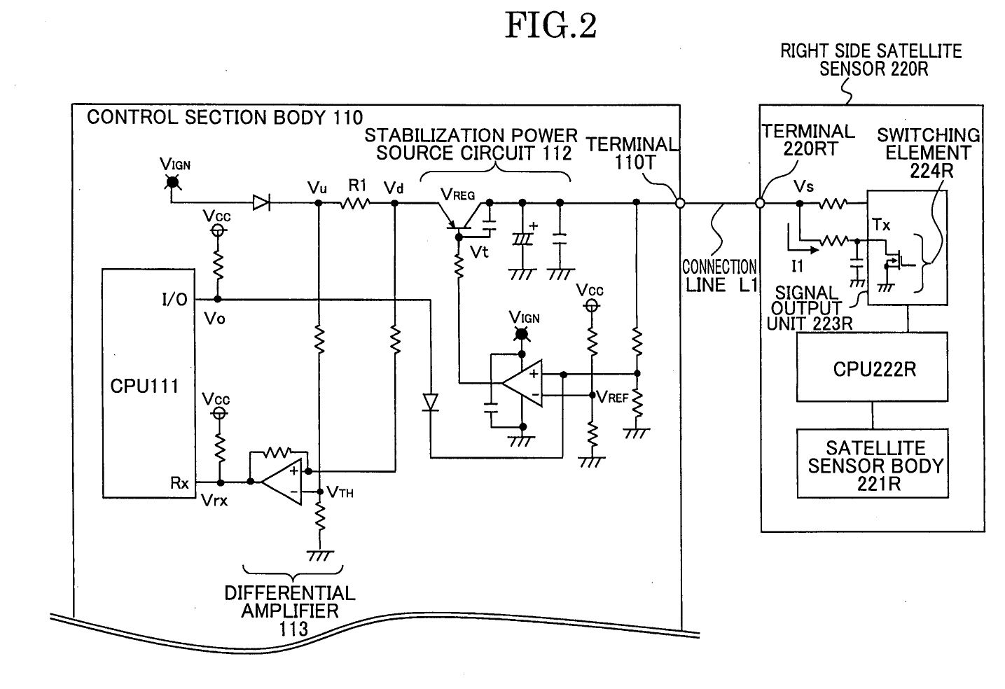

FIG. 2 shows a part of the circuits of the control section body 110 and the satellite sensor 200 (in this case, right side satellite sensor 220R) of the passenger protection device for a vehicle.

The control section body 110 includes a peripheral circuit having a CPU 111, a stabilization power source circuit 112, and a differential amplifier 113.

The CPU 111 is a microcomputer which performs the control of the control section 100.

The stabilization power source circuit 112 uses a voltage VIGN of a battery as input, and outputs a predetermined voltage VREG. The control section body 110 and the right side satellite sensor 220R include a terminal 110T of the control section body 110 and a terminal 220RT of the right side satellite sensor 220R, respectively, electrically connected by a connection line L1. The output voltage VREG of the stabilization power source circuit 112 is applied to the right side satellite sensor 220R as the power source voltage of the right side satellite sensor 220R via the connection line L1.

The right side satellite sensor 220R includes a satellite sensor body 221R, a CPU 222, and a signal output unit 223R having a switching element 224R.

The satellite sensor body 221 R is a sensor body which detects an impact.

The CPU 222R controls the operation of the right side satellite sensor 220R.

The signal output unit 223R sends the detected impact data to the control section body 110 via the connection line L1 by the on/off operation of the switching element 224R.

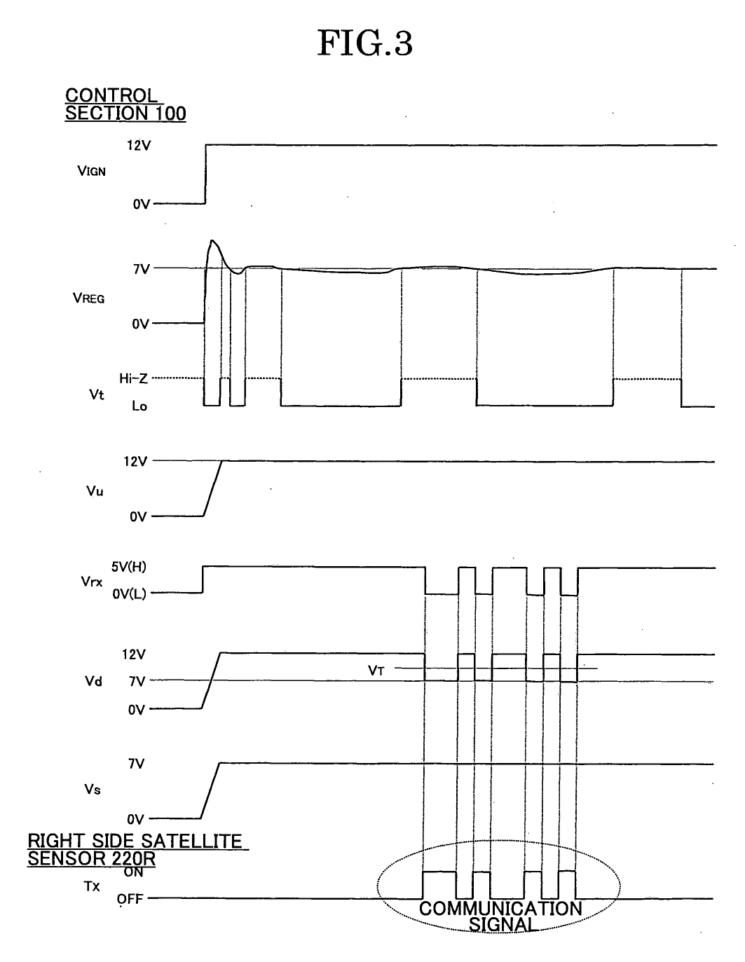

A resistance R1 is arranged on the upstream side (battery side) of the stabilization power source circuit 112 of the control section body 110. When the switching element 224R of the right side satellite sensor 220R is turned on, a current I1 flows, so an increased current flows into the resistance R1. Then, the electric potential Vd on the downstream side of the resistance R1 falls to the output voltage VREG (for example, 7V) of the stabilization power source circuit 112. On the other hand, when the switching element 224R of the right side satellite sensor 220 is turned off, the current I1 does not flow, so the current flowing into the resistance R1 is only a current required for operating the right side satellite sensor 220R. The current consumption of the satellite sensor 200 is generally set to be as low as possible, so this current is very little, and the electric potential Vd on the downstream side of the resistance R1 becomes a value close to the output voltage VIGN (12V) of the battery. The electric potential changes on both ends of the resistance R1 according to the on/off operation of the switching element 224R as illustrated in the timing chart in FIG. 3.

As described above, the electric potential difference on the both ends of the resistance R1 changes by the on/off of the switching element 224R of the right side satellite sensor 220R. By inputting this electric potential difference change into the differential amplifier 113, a signal synchronized to the on/off of the switching element 224R can be stably obtained. More particularly, the impact data detected by the right side satellite sensor 220R can be effectively input to the CPU 111 of the control section body 110.

In this case, since the resistance R1 is disposed between the battery and the stabilization power source circuit 112, when an external noise is mixed into the connection line L1, the impact data detected by the right side satellite sensor 220R is effectively input to the CPU 111 of the control section body 110 without being influenced by the external noise.

In the above description, the operation between the control section body 110 and the right side satellite sensor 220R was described, but the same operation is conducted for the operation between the control section body 110 and the front satellite sensor 210, and also the operation between control section body 110 and the left side satellite sensor 220L.

As described above, in the passenger protection device for a vehicle according to the embodiment of the present invention, when sharing the power source line as the communication line between the control section 100 and the satellite sensor 200, the communication can be stably conducted without being influenced by the external noise.

Although the present invention has been described in terms of an exemplary embodiment, it is not limited thereto. It should be appreciated that variations may be made in the embodiment described by persons skilled in the art without departing from the scope of the present invention as defined by the following claims.

For example, the block diagrams illustrated in FIGS. 1, 2 are examples. Another structure can be used as long as it conducts the above operation.

The number of satellite sensors 200 is not limited to the number illustrated in the above embodiment, and any number of satellite sensors can be used.

According to the embodiment of the present invention, when using the power source line between the control section and the satellite sensor as the communication line, the communication can be stably conducted without being influenced by an external noise.

According to the embodiment of the present invention, the control section can effectively receive the data of the satellite sensor.

What is claimed is:

1. A passenger protection device for a vehicle, comprising:
a satellite sensor which is disposed in a vehicle body, detects an impact applied to the vehicle body from outside as a deceleration, and outputs data; and
a control section which inflates an airbag arranged in a vehicle interior according to the data output from the satellite sensor, wherein
the control section and the satellite sensor are electrically connected by a connection line,
the control section outputs an operation voltage of the satellite sensor via the connection line,
the satellite sensor outputs the data to the control section via the connection line,
the control section includes a stabilization power source circuit which generates the operation voltage and a resistance provided between the stabilization power source circuit and a power source of the stabilization power source circuit,
the satellite sensor changes an electric potential difference on both ends of the resistance according to an output of the data, and
the control section loads the data of the satellite sensor according to the electric potential difference.

2. A passenger protection device for a vehicle according to claim 1, wherein the satellite sensor includes a switching element, and generates the data according to on/off of the switching element, so as to output the data.

3. A passenger protection device for a vehicle according to claim 1, wherein the control section includes a differential amplifier, and the differential amplifier outputs an output signal synchronized to the data according to the electric potential difference on both ends of the resistance.

4. A passenger protection device for a vehicle according to claim 2, wherein the control section includes a differential amplifier, and the differential amplifier outputs an output signal synchronized to the data according to the electric potential difference on both ends of the resistance.
